(19) United States
(12) Patent Application Publication
(10) Pub. No.: US 2023/0131823 A1
(43) Pub. Date: Apr. 27, 2023

(54) SYSTEMS, DEVICES AND METHODS FOR ON-DEMAND APPAREL

(71) Applicant: John Clarke Jackson, Bethesda, MD (US)

(72) Inventor: John Clarke Jackson, Bethesda, MD (US)

(21) Appl. No.: 17/452,424

(22) Filed: Oct. 27, 2021

(51) Int. Cl. G06Q 30/06; G06T 7/90

(52) U.S. Cl. CPC G06Q 30/0621; G06Q 30/0641; G06T 7/90

(57) ABSTRACT

Certain exemplary embodiments can provide systems and/or methods that can include: sending software to an information device, the software adapted to enable the user of the information device to customize one or more on-demand cut-and-sew apparel items. Such customizations may include, but are not limited to colors, designs, including but not limited to fabric designs, size adjustments, style selections and/or embellishments. Such software further adapted to enable the user of the information device to order and/or purchase such customized on-demand cut-and-sew apparel items. Such customizations are further incorporated into the creation and/or fulfillment of such on-demand cut-and-sew apparel items.

### CROSS-REFERENCE TO RELATED APPLICATION

This application claims priority to, and incorporates by reference herein in its entirety, pending U.S. Provisional Patent Application 63/198,696, filed Nov. 5, 2020.

### FIELD OF THE INVENTION

The present invention relates to novel systems and methods for the customization and fulfillment of such on-demand cut-and-sew apparel. More particularly, the invention relates to the generation of preview images, the generation of design variants, the customized printing of cut-and-sew patterns and the like.

### BACKGROUND

Consumer customization of on-demand cut-and-sew apparel has been offered by companies such as Original Stitch. However, certain such implementations suffer from drawbacks that hinder the process of customization and fulfillment of such on-demand cut-and-sew apparel.

These implementations typically make use of server-side rendering to update preview images in response to user customizations, which can result in a lack of responsiveness and/or a poor user experience.

These implementations also typically provide a single preview image, rather than multiple preview images.

These implementations also typically restrict the available fabric design choices to a limited number of selected and/or pre-printed options.

Therefore, a need exists for novel systems and methods for the customization and fulfillment of on-demand cut-and-sew apparel that facilitate client-side rendering to update preview images in response to user customizations.

Furthermore, a need exists for novel systems and methods for the customization and fulfillment of on-demand cut-and-sew apparel that incorporate multiple preview images, for example front, back, and/or side views, rendered in response to user customizations.

Additionally, a need exists for novel systems and methods for the customization and fulfillment of on-demand cut-and-sew apparel that incorporate the generation of one or more design variants based on one or more original designs, including but not limited to fabric designs.

Additionally, a need exists for novel systems and methods for the customization and fulfillment of on-demand cut-and-sew apparel that incorporate on-demand printing of designs, including but not limited to fabric designs, into apparel cut-and-sew patterns based on user selections and/or customizations.

### BRIEF SUMMARY OF THE INVENTION

Certain exemplary embodiments can provide systems and/or methods for the user of an information device to customize and/or order one or more on-demand cut-and-sew apparel items. Such customizations may include, but are not limited to colors, designs, including but not limited to fabric designs, size adjustments, style selections and/or embellishments. Such customizations are further incorporated into the creation and/or fulfillment of such on-demand cut-and-sew apparel items.

Certain exemplary embodiments can allow the user of the information device to preview such customizations in real time or near real time.

Certain exemplary embodiments can allow the user of the information device to view multiple preview images, for example front, back, and/or side views, rendered in response to such customizations.

Certain exemplary embodiments can allow the user of the information device to select from one or more design variants generated from one or more original designs, including but not limited to fabric designs, such variation including but not limited to color, scale, rotation, position, brightness, contrast, saturation, grayscale, inversion, composition and/or opacity.

Certain exemplary embodiments can allow the user of the information device to create one or more design variants generated from one or more original designs, including but not limited to fabric designs, such variation including but not limited to color, scale, rotation, position, brightness, contrast, saturation, grayscale, inversion, composition and/or opacity.

Certain exemplary embodiments can incorporate on-demand printing of designs, including but not limited to fabric designs, and/or design variants into apparel cut-and-sew patterns based on user selections and/or customizations into the creation and/or fulfillment of such on-demand cut-and-sew apparel items for the user of the information device.

### BRIEF DESCRIPTION OF THE DRAWINGS

A wide variety of potential practical and useful embodiments will be more readily understood through the following detailed description of certain exemplary embodiments, with reference to the accompanying exemplary drawings in which:

FIG. 1 is an exemplary illustration of an exemplary user interface;

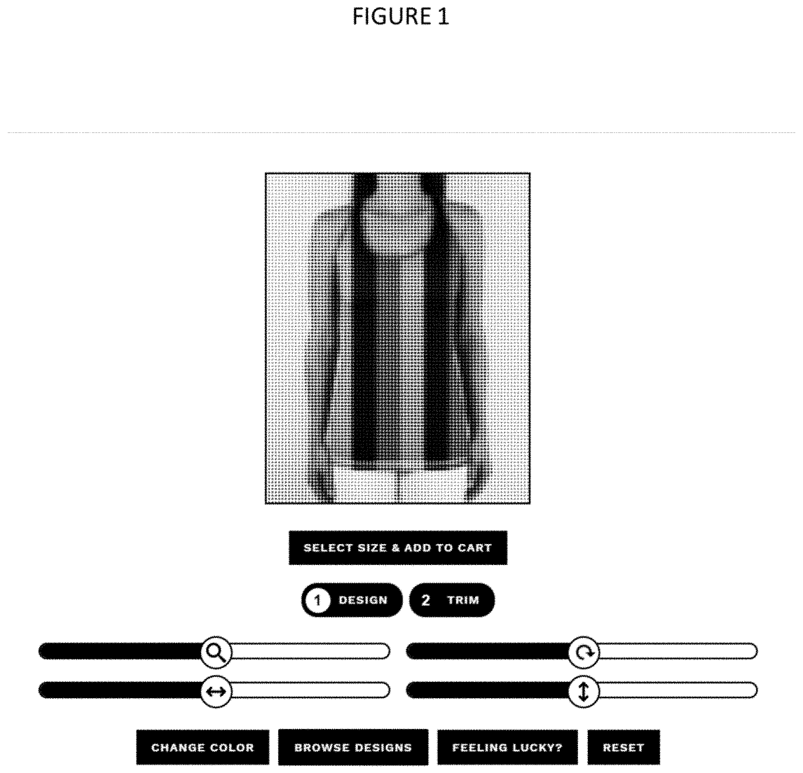

FIG. 2 is an exemplary illustration of an exemplary user interface;

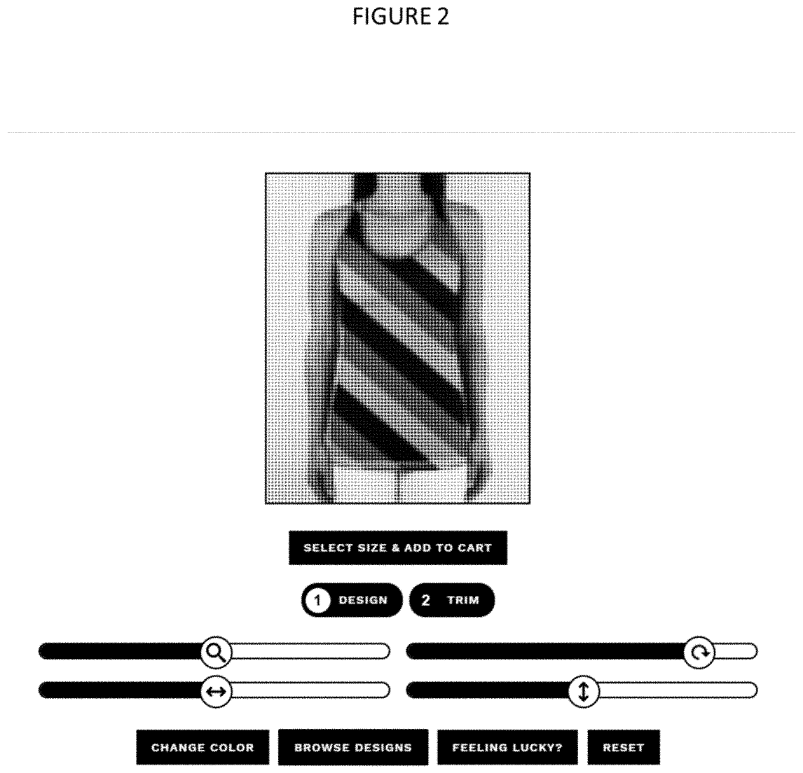

FIG. 3 is an exemplary illustration of an exemplary user interface;

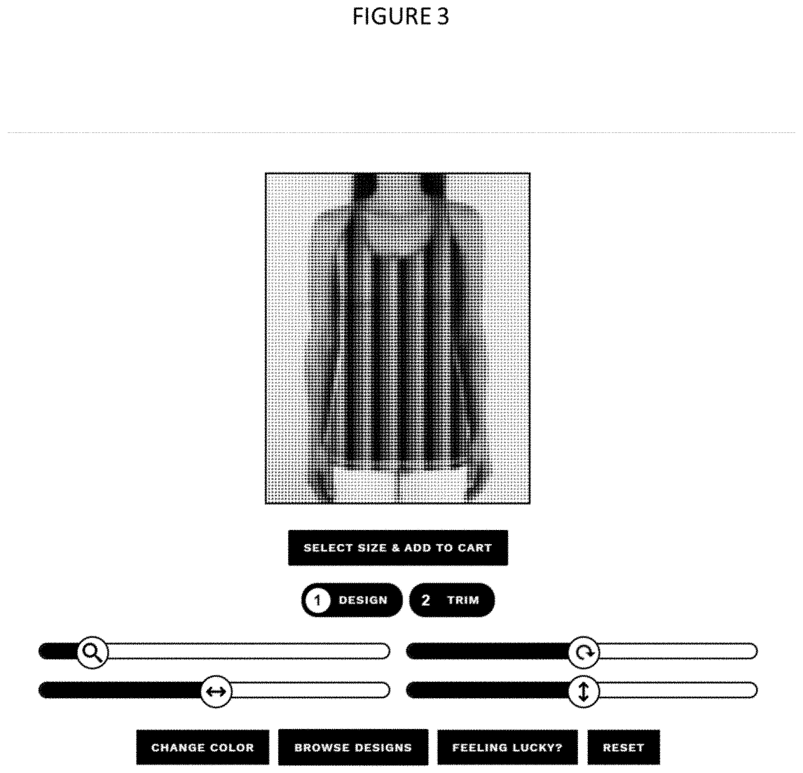

FIG. 4 is an exemplary illustration of an exemplary user interface;

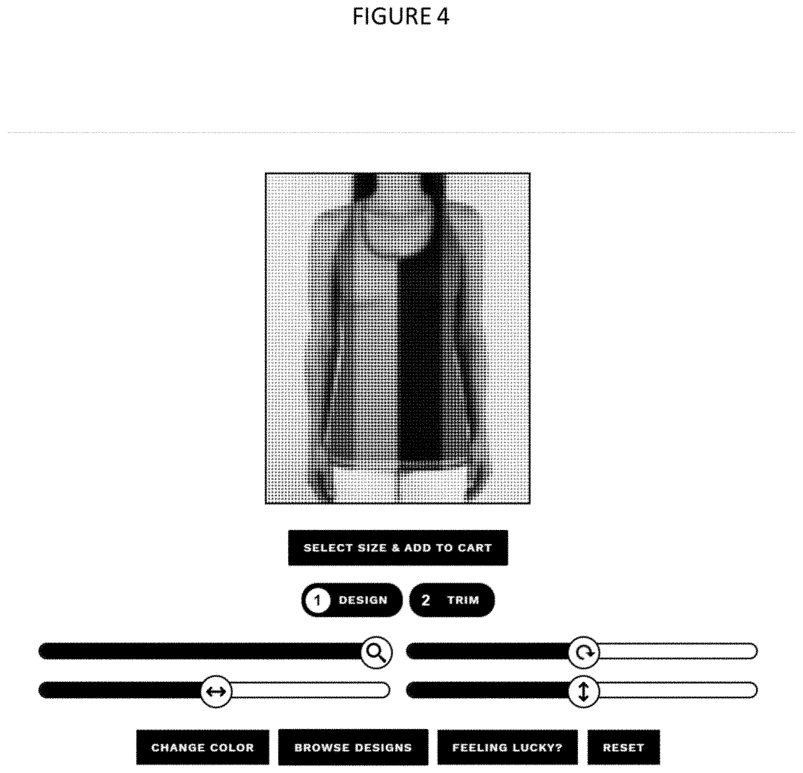

FIG. 5 is an exemplary illustration of an exemplary user interface;

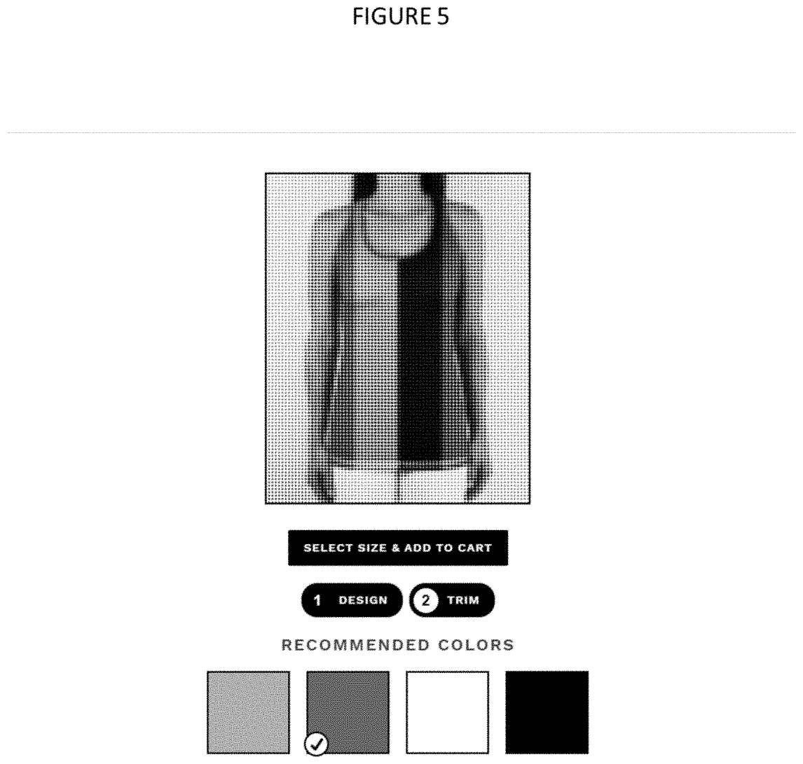

FIG. 6 is an exemplary illustration of an exemplary user interface;

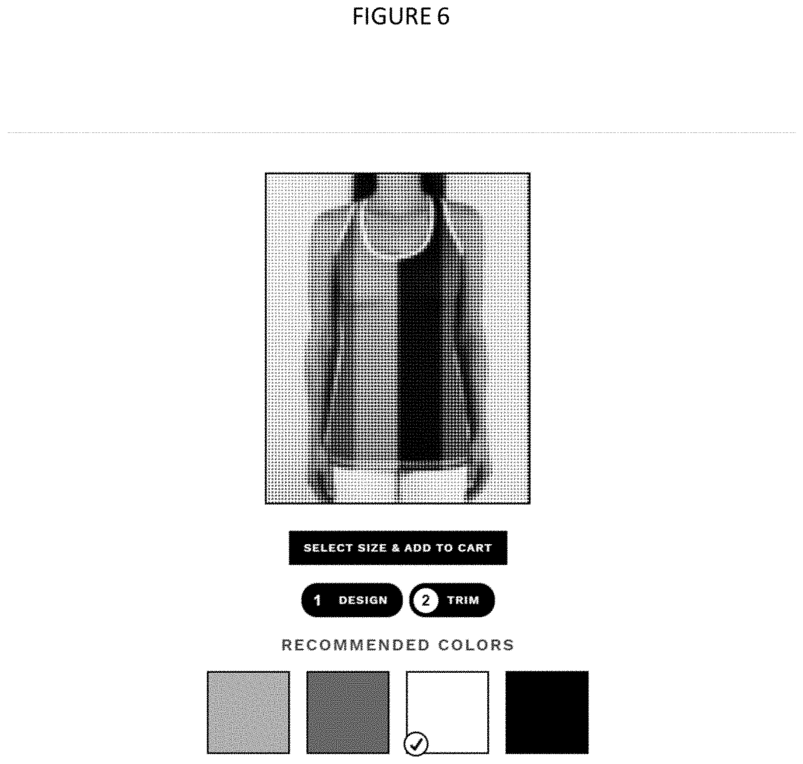

FIG. 7 is an exemplary illustration of an exemplary user interface;

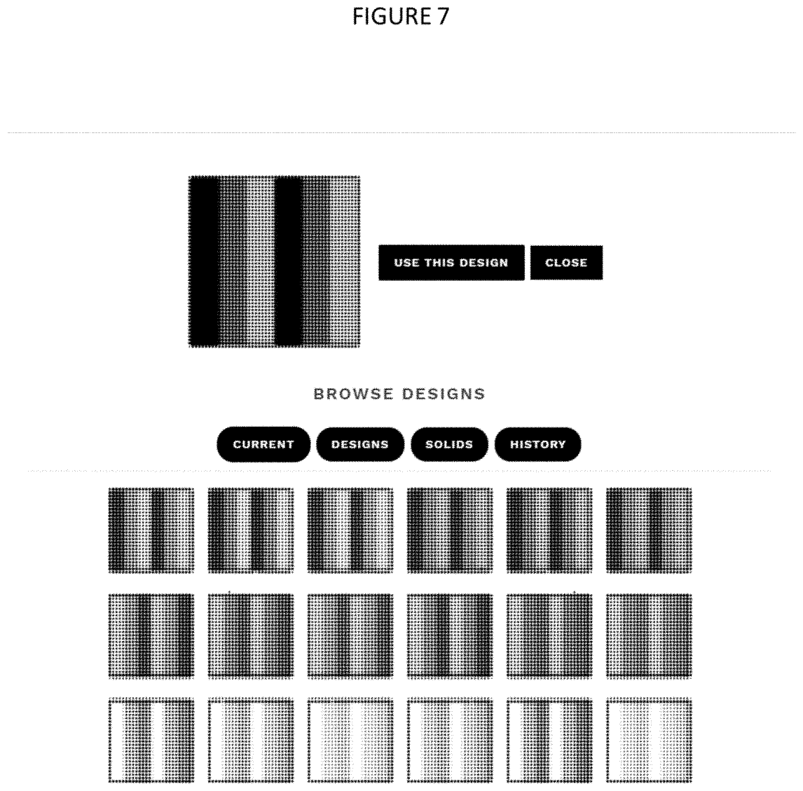

FIG. 8 is an exemplary illustration of an exemplary user interface;

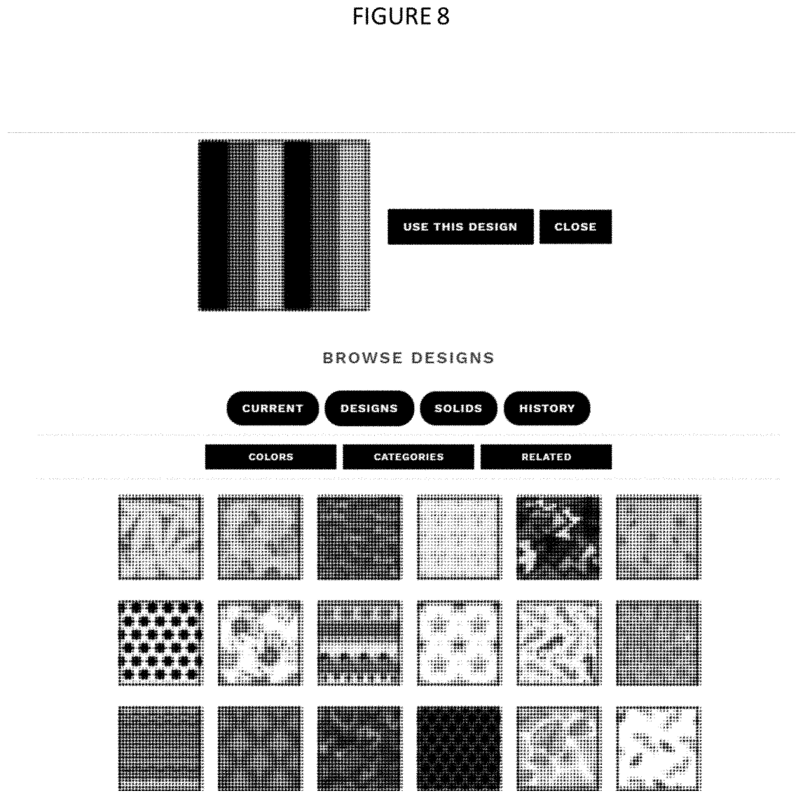

FIG. 9 is an exemplary illustration of an exemplary user interface;

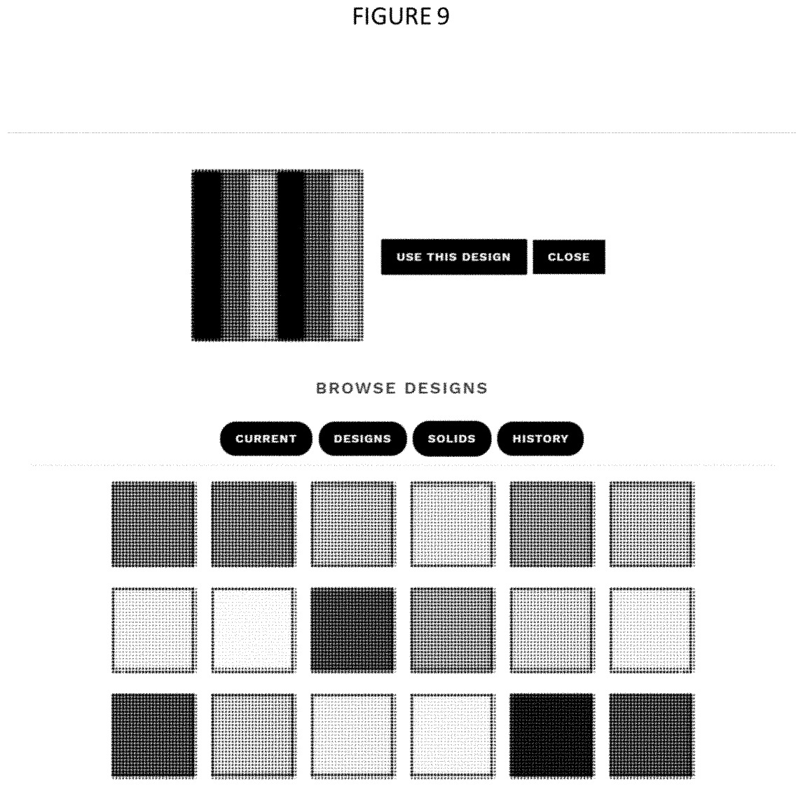

FIG. 10 is an exemplary illustration of an exemplary user interface;

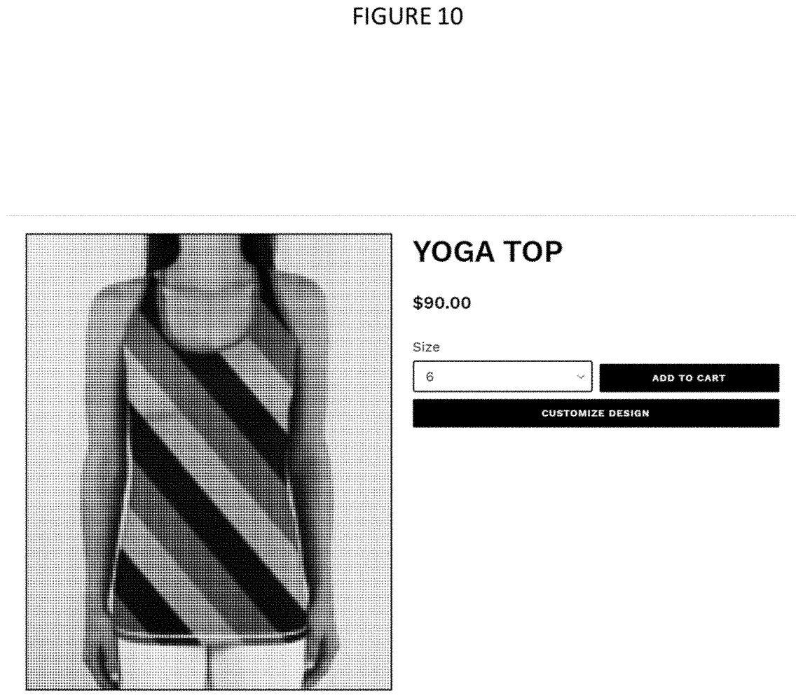

FIG. 11 is an exemplary illustration of an exemplary image layer;

FIG. 12 is an exemplary illustration of an exemplary image layer;

FIG. 13 is an exemplary illustration of an exemplary image layer;

FIG. 14 is an exemplary illustration of an exemplary image layer;

FIG. 15 is an exemplary illustration of an exemplary image layer;

FIG. 16 is an exemplary illustration of an exemplary image layer;

FIG. 17 is an exemplary illustration of an exemplary preview image;

FIG. 18 is an exemplary block diagram of an exemplary embodiment of a system; and

FIG. 19 is an exemplary flowchart of an exemplary embodiment of a method.

### DETAILED DESCRIPTION OF THE INVENTION

Certain exemplary embodiments can provide systems and/or methods that can include: sending software to an information device, the software adapted to enable the user of the information device to customize one or more on-demand cut-and-sew apparel items. Such customizations may include, but are not limited to colors, designs, including but not limited to fabric designs, size adjustments, style selections and/or embellishments. Such software further adapted to enable the user of the information device to order and/or purchase such customized on-demand cut-and-sew apparel items. Such customizations are further incorporated into the creation and/or fulfillment of such on-demand cut-and-sew apparel items.

Certain exemplary embodiments can enable the user of the information device to start the customization process with a template, data set, and/or other information regarding the initial state, provided programmatically and/or manually, of such on-demand cut-and-sew apparel items.

Certain exemplary embodiments can enable the user of the information device to start the customization process with a template, data set, and/or other information, provided programmatically and/or manually, regarding one or more previously customized on-demand cut-and-sew apparel items.

Certain exemplary embodiments can make use of image rendering on the information device and/or on a server to enable the user of the information device to view a preview image of such customizations.

Certain exemplary embodiments can make use of image rendering on the information device and/or on a server to enable the user of the information device to view a dynamic preview image of such customizations rendered in real time or near real time.

Certain exemplary embodiments can make use of image rendering on the information device and/or on a server to enable the user of the information device to view multiple preview images, for example front, back, and/or side views, rendered in response to such customizations.

Certain exemplary embodiments can make use of image rendering on the information device and/or on a server to enable the user of the information device to view multiple dynamic preview images, for example front, back, and/or side views, rendered in response to such customizations in real time or near real time.

Certain exemplary embodiments can use single-layer images for preview images.

Certain exemplary embodiments can use multi-layer images for preview images.

Certain exemplary embodiments can use multi-layer images for preview images, which are later converted into single-layer preview images.

Certain exemplary embodiments can store data regarding such customizations.

Certain exemplary embodiments can transmit the data regarding such customizations from the information device to a server.

Certain exemplary embodiments can assign an identifier to the data regarding such customizations.

Certain exemplary embodiments can assign the same identifier when the same customizations are applied by different users.

Certain exemplary embodiments can use the data regarding such customizations to render and/or modify one or more preview images on the information device and/or on a server.

Certain exemplary embodiments can store, record, transmit and/or otherwise publish data and/or information regarding such customized on-demand cut-and-sew apparel items, including but not limited to product specifications, customization data and/or rendered preview images to a database, product catalog, ecommerce platform and/or other system.

Certain exemplary embodiments can allow the user of the information device to add such customized on-demand cut-and-sew apparel items to an ecommerce cart.

Certain exemplary embodiments can allow the user of the information device to purchase, order and/or other request fulfillment of such customized on-demand cut-and-sew apparel items.

Certain exemplary embodiments can allow the user of the information device to make additional selections, provided programmatically and/or manually, including but not limited to size, before purchasing, ordering and/or other requesting fulfillment of such customized on-demand cut-and-sew apparel items.

Certain exemplary embodiments can allow the user of the information device to share information about such customized on-demand cut-and-sew apparel items, including but not limited to one or more preview images.

Certain exemplary embodiments can allow the user of the information device to share a link, URL, and/or other method to enable other consumers to purchase, order and/or otherwise request fulfillment of such customized on-demand cut-and-sew apparel items.

Certain exemplary embodiments can feature, promote, display or otherwise enable other consumers to purchase, order and/or other request fulfillment of such customized on-demand cut-and-sew apparel items.

Certain exemplary embodiments can allow other consumers to change, modify and/or otherwise adjust the customizations of such customized on-demand cut-and-sew apparel items, resulting in one or more variations of such customized on-demand cut-and-sew apparel items.

Certain exemplary embodiments can treat one or more variations of such customized on-demand cut-and-sew apparel items as new customized on-demand cut-and-sew apparel items.

Certain exemplary embodiments can allow the user of the information device to receive a commission, payment and/or other type of reward and/incentive when other consumers purchase, order and/or other request fulfillment of such customized on-demand cut-and-sew apparel items and/or such variations of such customized on-demand cut-and-sew apparel items.

Certain exemplary embodiments can insert, post, push and/or otherwise add data and/or information regarding such customized on-demand cut-and-sew apparel items to a system, platform, database, queue, list and/or other method to enable the production and/or fulfillment of such customized on-demand cut-and-sew apparel items.

Certain exemplary embodiments can notify the user of the information device one or more times regarding the state and/or stage of such customized on-demand cut-and-sew apparel items in the production and/or fulfillment process, including but not limited to states and/or stages such as received, verifying, printing, cutting, sewing, quality assurance, shipped, delivered, delayed. Such notifications can include, but are not limited to emails, push notifications, in-app notifications, instant messages, text messages, and/or SMS.

Certain exemplary embodiments can render one or more production images and/or files, including high-resolution and/or print-ready images and/or files, based on data and/or information regarding such customized on-demand cut-and-sew apparel items.

Certain exemplary embodiments can print such production images on demand on fabric and/or other materials using methods including, but not limited to, dye sublimation.

Certain exemplary embodiments can render and/or select one or more cut & sew patterns and/or files, based on data and/or information regarding such customized on-demand cut-and-sew apparel items.

Certain exemplary embodiments can cut one or more pattern pieces based on such cut & sew patterns and/or files. Such pattern pieces can be cut manually and/or automatically, for example by machine.

Certain exemplary embodiments can cut one or more pattern pieces from such on-demand printed fabric and/or other materials.

Certain exemplary embodiments can cut one or more pattern pieces from pre-printed and/or otherwise previously created fabric and/or other materials.

Certain exemplary embodiments can sew and/or otherwise assemble one or more such pattern pieces together. Such pattern pieces can be sewn and/or otherwise assembled manually and/or automatically, for example by machine.

Certain exemplary embodiments can incorporate standard and/or custom features including, but not limited to, buttons, zippers, clasps, snaps, drawstrings, bows, embroidery, beading, lace, fringe, patches, appliques, rivets, studs, crystals, leather, and/or other embellishments, decorations, fasteners, accents and/or other types of features. Such embellishments, decorations, fasteners, accents and/or other types of features can be incorporated and/or otherwise assembled manually and/or automatically, for example by machine.

Certain exemplary embodiments can enable the user of the information device to customize one or more areas, features and/or zones of such customized on-demand cut-and-sew apparel items.

Certain exemplary embodiments can include a single customizable area, feature and/or zone per individual pattern piece.

Certain exemplary embodiments can include multiple customizable areas, features and/or zones per individual pattern piece.

Certain exemplary embodiments can include one or more customizable areas, features and/or zones spanning multiple pattern pieces.

Certain exemplary embodiments can enable the application of a thread-stitched seam between one or more customizable areas, features and/or zones within a single pattern piece and/or between multiple pattern pieces.

Certain exemplary embodiments can synchronize one or more customizations across multiple customizable areas, features and/or zones, including but not limited to applying the same fabric design selection to multiple customizable areas, features and/or zones.

Certain exemplary embodiments can determine, calculate and/or otherwise set, programmatically and/or manually, one or more customizations across one or more customizable areas, features and/or zones on one or more such customized on-demand cut-and-sew apparel items based on information regarding one or more different customizations across one or more different customizable areas, including but not limited to applying a fabric design selection to one customizable area and the calculated primary color of such fabric design selection to a different customizable area on one or more such customized on-demand cut-and-sew apparel items.

Certain exemplary embodiments can determine, calculate and/or otherwise provide, programmatically and/or manually, one or more recommendation to the user of the information device for one or more customizations across one or more customizable areas, features and/or zones on one or more such customized on-demand cut-and-sew apparel items based on information regarding one or more different customizations across one or more different customizable areas, including but not limited to applying a fabric design selection to one customizable area and recommending different color options based on such fabric design selection to the user of the information device for a different customizable area on one or more such customized on-demand cut-and-sew apparel items.

Certain exemplary embodiments can enable the user of the information device to select a thread color one or more customizable seams, areas, features and/or zones.

Certain exemplary embodiments can enable the user of the information device to select a thread stitch style, including but not limited to plain, flatlock or coverstitch, for one or more customizable seams, areas, features and/or zones.

Certain exemplary embodiments can enable the user of the information device to select one or more images, colors, patterns, designs, symbols, logos, characters, text, artwork and/or other forms of decoration and/or styling to be printed and/or otherwise incorporated on and/or into one or more customizable areas, features and/or zones.

Certain exemplary embodiments can enable the user of the information device to select and layer one or more images, colors, patterns, designs, symbols, logos, characters, text, artwork and/or other forms of decoration and/or styling to be printed and/or otherwise incorporated on and/or into one or more customizable areas, features and/or zones.

Certain exemplary embodiments can enable the user of the information device to select and adjust the opacity and/or blend more between one or more layers of images, colors, patterns, designs, symbols, logos, characters, text, artwork and/or other forms of decoration and/or styling to be printed and/or otherwise incorporated on and/or into one or more customizable areas, features and/or zones.

Certain exemplary embodiments can enable the user of the information device to tile or otherwise repeat in a pattern or otherwise one or more images, colors, patterns, designs, symbols, logos, characters, text, artwork and/or other forms of decoration and/or styling to be printed and/or otherwise incorporated on and/or into one or more customizable areas, features and/or zones.

Certain exemplary embodiments can enable the user of the information device to mirror or otherwise transform one or more images, colors, patterns, designs, symbols, logos, characters, text, artwork and/or other forms of decoration and/or styling in a way that allows it to be tiles or otherwise repeated to be printed and/or otherwise incorporated on and/or into one or more customizable areas, features and/or zones.

Certain exemplary embodiments can enable the user of the information device to scale, zoom, rotate, turn, skew, stretch, move, position and/or otherwise transform one or more images, colors, patterns, designs, symbols, logos, characters, text, artwork and/or other forms of decoration and/or styling to be printed, stamped, cut and/or otherwise incorporated on and/or into one or more customizable areas, features and/or zones.

Certain exemplary embodiments can enable the user of the information device to scale, zoom, rotate, turn, skew, stretch, move, position, blend, mask and/or otherwise transform one or more images, colors, patterns, designs, symbols, logos, characters, text, artwork and/or other forms of decoration and/or styling to be printed and/or otherwise incorporated on and/or into one or more customizable areas, features and/or zones.

Certain exemplary embodiments can enable the user of the information device to make adjustments including, but not limited to, hue, brightness, contrast, saturation, grayscale, inversion, highlights and/or shadows, and/or otherwise implement and/or apply one or more filters, matrices, translations, transformations, adjustments, algorithms, procedures, calculations, macros, programs, utilities and/or other such effects to one or more images, colors, patterns, designs, symbols, logos, characters, text, artwork and/or other forms of decoration and/or styling to be printed and/or otherwise incorporated on and/or into one or more customizable areas, features and/or zones.

Certain exemplary embodiments can enable the user of the information device to select one or more types of fabric and/or other types of materials and/or components to be used for and/or otherwise incorporated on and/or into one or more customizable areas, features and/or zones.

Certain exemplary embodiments can enable the user of the information device to upload, enter, configure, transfer, transmit, reference, select and/or otherwise provide an images, colors, patterns, designs, symbols, logos, characters, text, artwork and/or other forms of decoration and/or styling and/or similar file, data and/or information to be printed and/or otherwise incorporated on and/or into one or more customizable areas, features and/or zones.

Certain exemplary embodiments can determine, calculate and/or otherwise set, programmatically and/or manually, initial and/or default values for such customizations.

Certain exemplary embodiments can determine, calculate and/or otherwise set, programmatically and/or manually, one or more ratios, formulas, algorithms, calculations and/or other similar methods for rendering multiple preview images of different sizes using information regarding such customizations.

Certain exemplary embodiments can determine, calculate and/or otherwise set, programmatically and/or manually, one or more ratios, formulas, algorithms, calculations and/or other similar methods for rendering multiple preview images of different sizes based on data and/or information regarding such customized on-demand cut-and-sew apparel items.

Certain exemplary embodiments can determine, calculate and/or otherwise set, programmatically and/or manually, one or more ratios, formulas, algorithms, calculations and/or other similar methods for rendering one or more production images and/or files of different sizes, including high-resolution and/or print-ready images and/or files, for based on data and/or information regarding such customized on-demand cut-and-sew apparel items. For example, the calculation and/or implementation of a customization such as zoom level for a design image may need to be different for a garment of size Small compared to a garment of size Large in order to produce a similar result for each size.

Certain exemplary embodiments can allow the user of the information device to make adjustments to one or more cut & sew patterns and/or files, including but not limited to modifying the length, width, and/or otherwise changing the shape of one or more pattern pieces, including but not limited to body length, sleeve length, chest size, inseam, and/or waist size.

Certain exemplary embodiments can allow the user of the information device to add and/or remove one or more pattern pieces and/or pattern details in one or more cut & sew patterns and/or files, including but not limited to changing between short sleeves and long sleeves, changing between buttons and zippered closures, changing collar style, and/or adding or removing a side panel, bottom panel, and/or patch.

Certain exemplary embodiments can allow the user of the information device to select from one or more design variants generated from one or more original designs, including but not limited to fabric designs, such variation including but not limited to color, scale, rotation, position, brightness, contrast, saturation, grayscale, inversion, composition and/or opacity.

Certain exemplary embodiments can allow the user of the information device to create one or more design variants generated from one or more original designs, including but not limited to fabric designs, such variation including but not limited to color, scale, rotation, position, brightness, contrast, saturation, grayscale, inversion, composition and/or opacity.

Certain exemplary embodiments can enable the categorization, indexing, tagging and/or otherwise organizing and/or optimizing one or more designs, including but not limited to fabric designs, and/or design variations for searching, recommending, listing and/or otherwise finding, presenting and/or displaying by and/or to the user of the information device using data and/or attributes including but not limited to color, brightness, complexity, style, content and/or creator.

Certain exemplary embodiments can enable such categorization, indexing, tagging and/or otherwise organizing and/or optimizing one or more designs, including but not limited to fabric designs, and/or design variations manually.

Certain exemplary embodiments can enable such categorization, indexing, tagging and/or otherwise organizing and/or optimizing one or more designs, including but not limited to fabric designs, and/or design variations automatically and/or programmatically through one or more algorithms incorporating algorithm input data including but not limited to the image pixel data representing such design or variation.

Certain exemplary embodiments can randomly set one or more values of one or more such customizations, including but not limited to color and/or fabric design, from a range, collection and/or similar such set of potential value.

Certain exemplary embodiments can enable the user of the information device to earn money, points, prizes, rewards and/or other such compensation and/or recognition related to the purchase by other users of one or more such on-demand cut-and-sew apparel items customized by said user of the information device.

Certain exemplary embodiments can enable the user of the information device to create lists, pages, store fronts and/or other such collections containing one or more such on-demand cut-and-sew apparel items customized by said user of the information device.

Certain exemplary embodiments can allow the system to be used by and/or for one or more different companies, clients, customers, brands and/or tenants including, but not limited to, as a hosted SAAS platform and/or service.

Certain exemplary embodiments can allow the system to be white-labeled, modified and/or otherwise customized by and/or for one or more different companies, clients, customers, brands and/or tenants, such modifications and/or customizations including, but not limited to logo, font, styles, colors, customizable products, recommendations, designs, including but not limited to fabric designs, and/or design variants.

Certain exemplary embodiments can allow one or more components, features, utilities or other such functions and/or functionality of the system to be accessed using and/or delivered through one or more web sites, mobile applications and/or other similar digital properties.

Certain exemplary embodiments can allow one or more components, features, utilities or other such functions and/or functionality of the system to be accessed using and/or delivered through one or more Application Programming Interfaces (APIs).

Certain exemplary embodiments can allow one or more components, features, utilities or other such functions and/or functionality of the system to be accessed using and/or delivered through one or more Software Development Kits (SDKs).

Certain exemplary embodiments can allow one or more components, features, utilities or other such functions and/or functionality of the system to be accessed using and/or delivered through one or more embedded widgets.

Certain exemplary embodiments can allow one or more components, features, utilities or other such functions and/or functionality of the system to be accessed through, embedded in, contained within and/or otherwise integrated one or more web sites, mobile application and/or other similar digital properties of one or more different companies, clients, customers, brands and/or tenants.

Certain exemplary embodiments can provide one or more customization options, including but not limited to color and/or fabric design, for one or more customizable areas, features and/or zones of one or more such customized on-demand cut-and-sew apparel items.

Certain exemplary embodiments can provide one or more customization option attributes, including but not limited to scale and/or rotation, for such customization options.

Certain exemplary embodiments can provide one or more customization option attribute controls, including but not limited to catalogs, range sliders and/or buttons, to enable the user of the information device to set one or more customization option attribute values for such customization option attributes.

Certain exemplary embodiments can provide, programmatically and/or manually, default values and/or recommended values for such customization option attributes and/or customization option attribute controls.

Certain exemplary embodiments can render one or more such preview images using a markup language and/or other such image rendering format including, but not limited to, SVG and/or XML.

Certain exemplary embodiments can render one or more such preview images using one or more image layers.

Certain exemplary embodiments can render one or more such preview images using one or more raster images.

Certain exemplary embodiments can render one or more such preview images using one or more vector images.

Certain exemplary embodiments can apply one or more such transformations and/or adjustments to one or more such layers in response to one or more such customization option attribute values.

Certain exemplary embodiments can render one or more such preview images using one or more image masks.

Certain exemplary embodiments can render one or more such preview images using one or more texture layers, including but not limited to one or highlight layers and/or one or more shadow layers.

Certain exemplary embodiments can render one or more preview images displaying such customizations by the user of the information device incorporated into one or more photographs or other such images that include representations of one or more such on-demand cut-and-sew apparel items.

Certain exemplary embodiments can provide such systems and/or methods herein for on-demand cut-and-sew items not limited to apparel items, including but not limited to napkins, tablecloths, table runners, pillow covers, and/or bed linens.

Certain exemplary embodiments can provide such systems and/or methods herein for on-demand manufactured items not limited to cut-and-sew items, including but not limited to fitness mats, rugs, tile, wallpaper, wrapping paper, luggage, tableware, and/or artwork.

Certain exemplary embodiments can provide such systems and/or methods herein for on-demand items not created, assembled, produced and/or otherwise manufactured on-demand, but rather created, assembled, produced and/or otherwise manufactured in advance.

### DRAWINGS

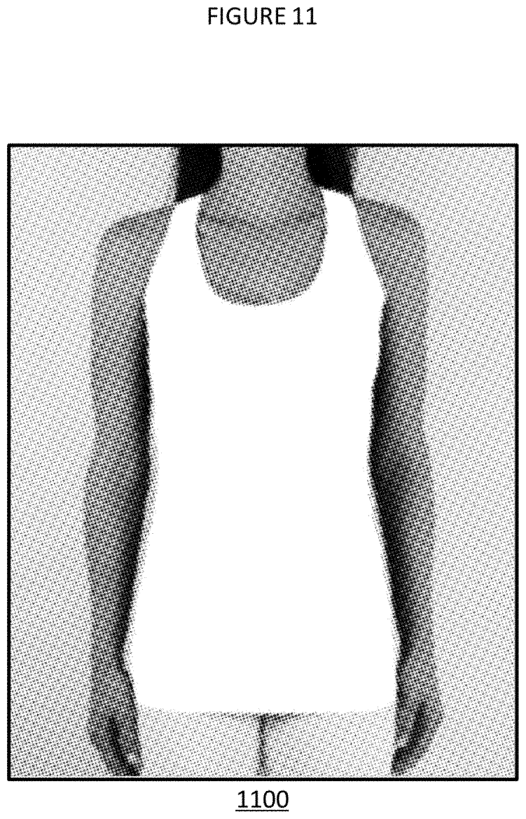

FIGS. 11, 12, 13, 14, 15, 16 are exemplary illustrations of exemplary image layers 1100, 1200, 1300, 1400, 1500, 1600. Certain exemplary embodiments can render one or more such preview images 1700 using one or more image layers 1100, 1200, 1300, 1400, 1500, 1600.

FIG. 11 is an exemplary illustration of an exemplary image layer 1100. Certain exemplary embodiments can render one or more preview images displaying such customizations by the user of the information device incorporated into one or more photographs 1100 or other such images that include representations of one or more such on-demand cut-and-sew apparel items.

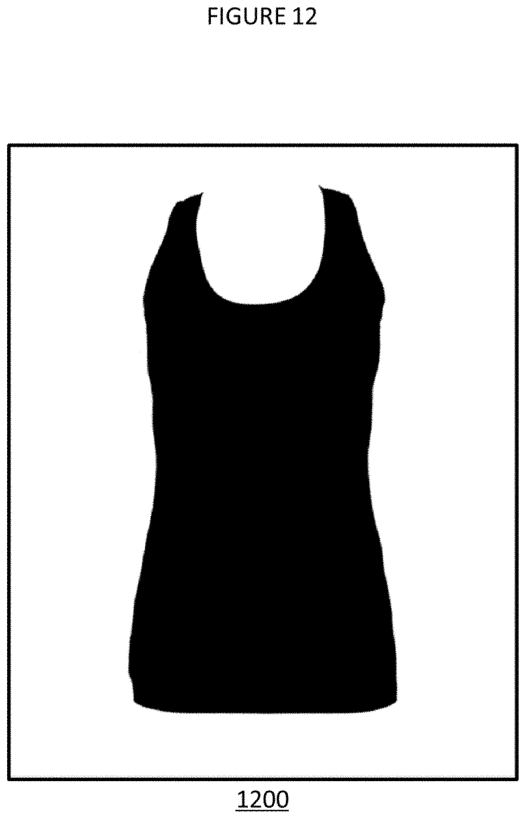

FIGS. 12, 13, 14 are exemplary illustrations of exemplary image layers 1200, 1300, 1400. Certain exemplary embodiments can render one or more such preview images using one or more image masks 1200, 1300, 1400.

FIG. 12 is an exemplary illustration of an exemplary image layer 1200. Certain exemplary embodiments can render one or more such preview images using one or more image masks 1200 to reveal customizations for the body of such on-demand cut-and-sew apparel items.

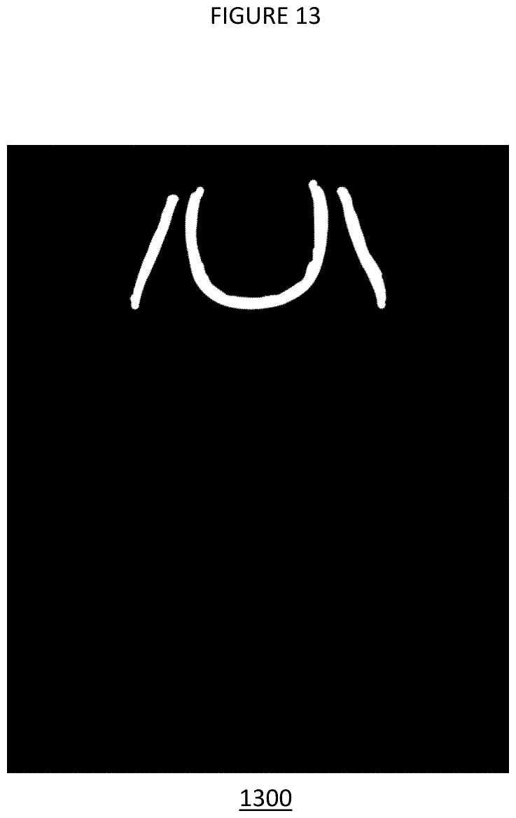

FIG. 13 is an exemplary illustration of an exemplary image layer 1300. Certain exemplary embodiments can render one or more such preview images using one or more image masks 1300 to reveal customizations for the trim of such on-demand cut-and-sew apparel items.

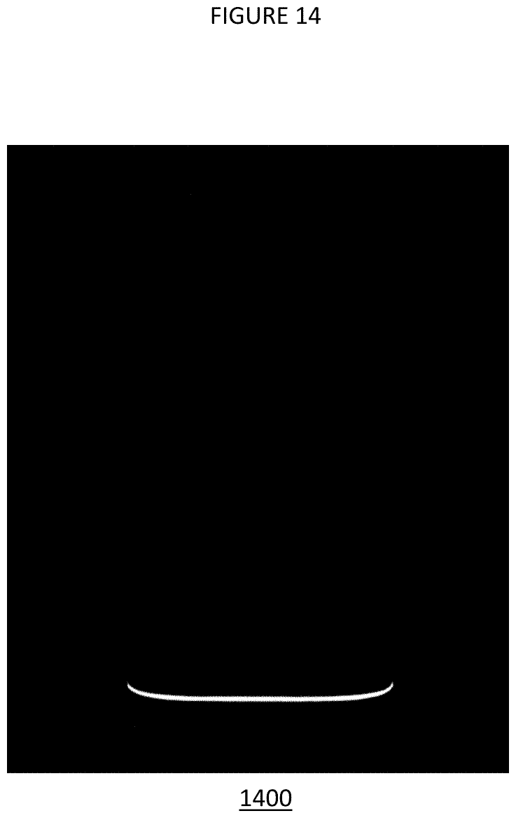

FIG. 14 is an exemplary illustration of an exemplary image layer 1400. Certain exemplary embodiments can render one or more such preview images using one or more image masks 1400 to reveal customizations for the thread of such on-demand cut-and-sew apparel items.

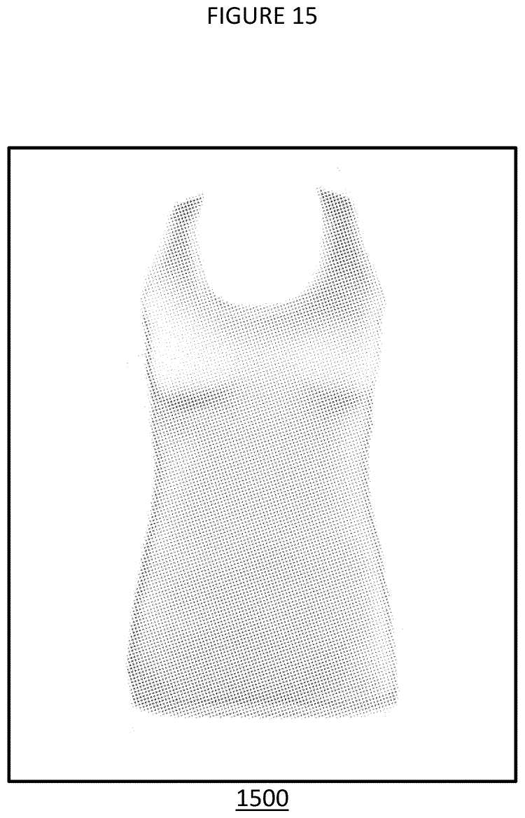

FIG. 15 is an exemplary illustration of an exemplary image layer 1500. Certain exemplary embodiments can render one or more such preview images using one or more texture layers 1500, including but not limited to one or highlight layers and/or one or more shadow layers.

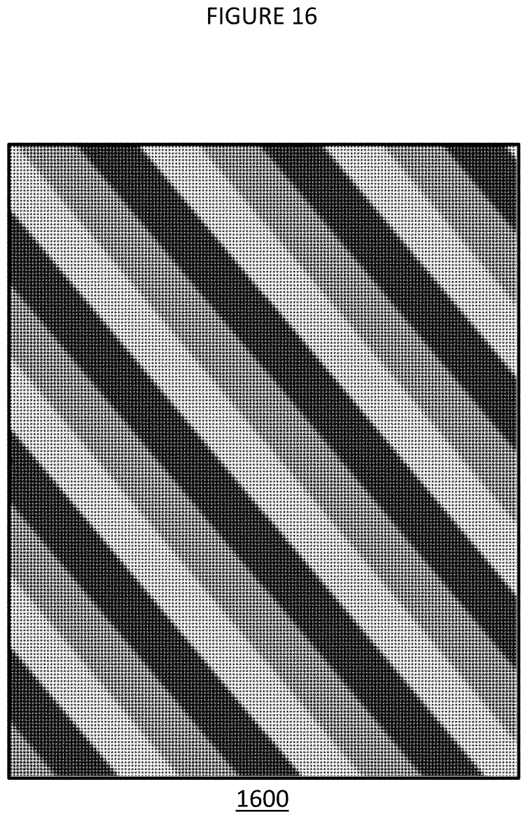

FIG. 16 is an exemplary illustration of an exemplary image layer 1600. Certain exemplary embodiments can render one or more such preview images using one or more raster images 1600.

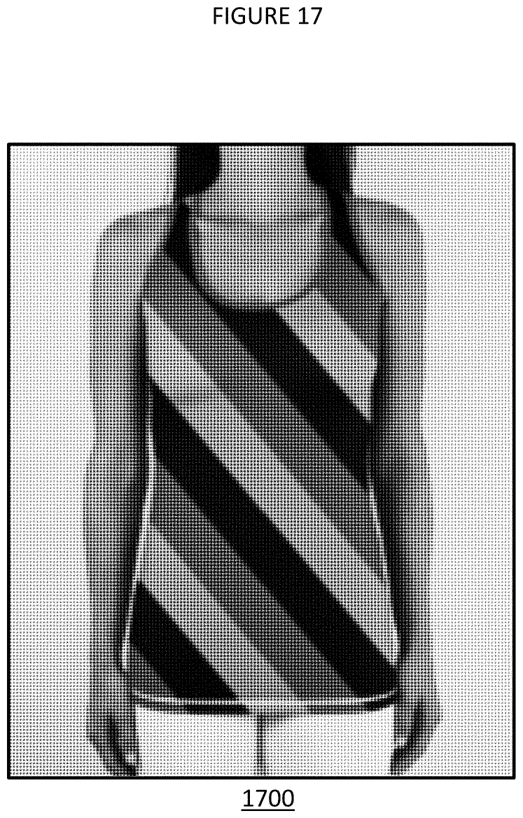

FIG. 17 is an exemplary illustration of an exemplary preview image 1700. Certain exemplary embodiments can render one or more preview images 1700 displaying such customizations by the user of the information device incorporated into one or more photographs or other such images that include representations of one or more such on-demand cut-and-sew apparel items.

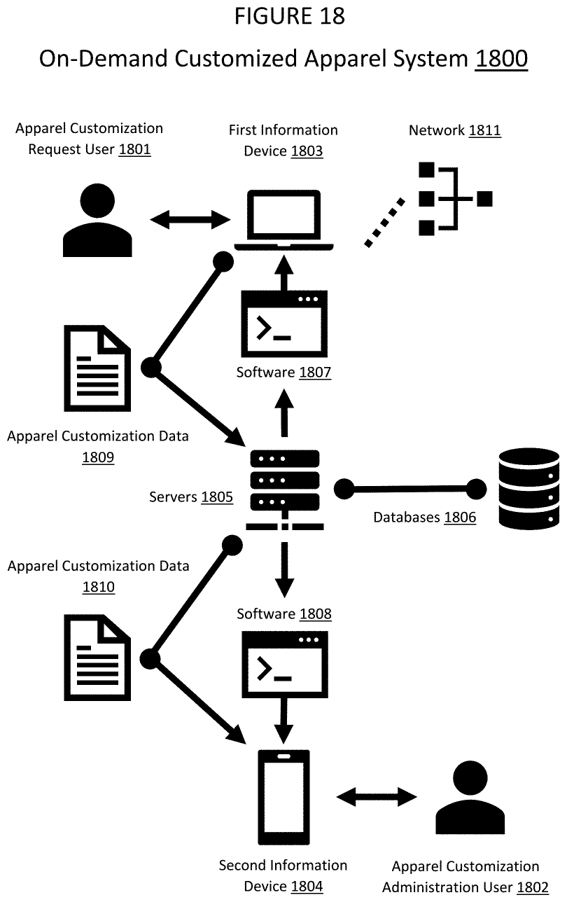

FIG. 18 is a block diagram of an exemplary embodiment of a system 1800 which can comprise any number of information devices 1803, 1804, which can be communicatively coupled via a network 1811.

Also coupled to network 1811 can be any number of servers 1905. A server can include a server software application. A server can be coupled to a data storage device, repository, and/or databases 1806. A server can include an administrator user interface and/or database management software.

Certain exemplary embodiments include: sending software 1807, 1808 to a first information device 1803 and a second information device 1804, the software 1807 adapted to enable the user 1801 of the first information device 1803 to create a request for the production of one or more customized cut-and-sew apparel items; providing data associated with that request 1809, 1810 to the software running on the second information device 1804, the software 1808 adapted to enable the user 1802 of the second information device 1804 to manage the production process for customized cut-and-sew apparel items incorporating data from the request 1809, 1810.

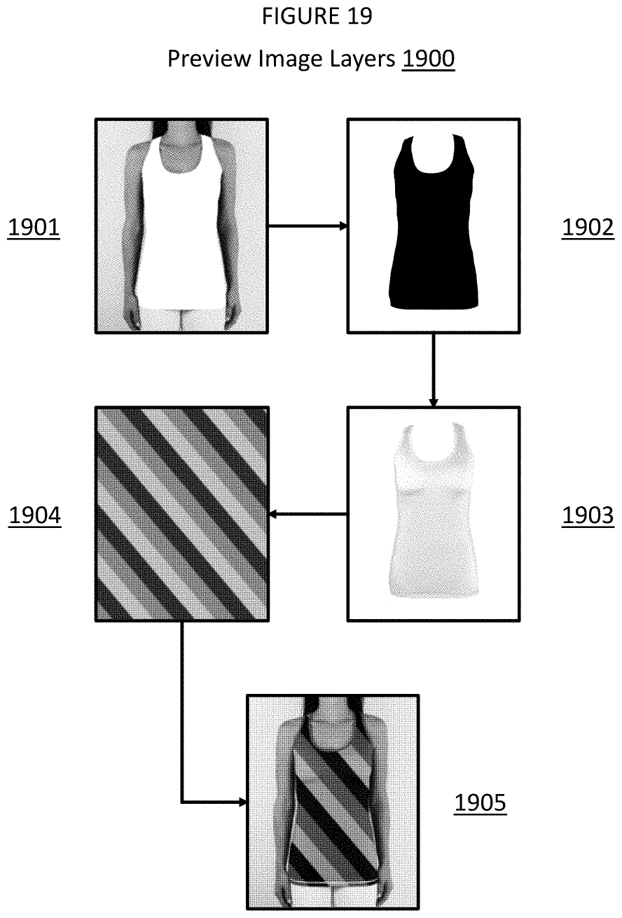

FIG. 19 is an exemplary flowchart of an exemplary embodiment of a method 1900 which can comprise any number of image layers 1901, 1902, 1903, 1904 which can be programmatically combined to generate a preview image 1905.

Certain exemplary embodiments include: applying a mask 1902 to an image 1901; placing a semi-transparent texture image layer 1903 on a design image layer 1904; placing such layers 1903, 1904 behind such image 1901, revealed by image mask 1902, resulting in the preview image 1905.

Certain exemplary embodiments include scaling, zooming, rotating, turning, skewing, stretching, moving, positioning and/or otherwise transforming such design image layer 1904.

Certain exemplary embodiments include making adjustments including, but not limited to, hue, brightness, contrast, saturation, grayscale, inversion, highlights and/or shadows, and/or otherwise implementing and/or applying one or more filters, matrices, translations, transformations, adjustments, algorithms, procedures, calculations, macros, programs, utilities and/or other such effects to such design image layer 1904.

Certain exemplary embodiments include replacing such design image layer 1904 with a different design image layer.

Certain exemplary embodiments include replacing such design image layer 1904 with a color and/or color gradient.

### Definitions

When the following terms are used substantively herein, the accompanying definitions apply. These terms and definitions are presented without prejudice, and, consistent with the application, the right to redefine these terms via amendment during the prosecution of this application or any application claiming priority hereto is reserved. For the purpose of interpreting a claim of any patent that claims priority hereto, each definition in that patent functions as a clear and unambiguous disavowal of the subject matter outside of that definition.
a—at least one.
activity—an action, act, step, and/or process or portion thereof.
adapted to—made suitable or fit for a specific use or situation.
algorithm—an algorithm may include, but is not limited to, a calculation, process, set of rules, problem-solving operation, mathematical formula, software program, machine instructions, machine learning, artificial intelligence or neural network.
and/or—either in conjunction with or in alternative to.
apparatus—an appliance or device for a particular purpose.
associate—to join, connect together, and/or relate.
automatically—acting or operating in a manner essentially independent of external influence or control. For example, an automatic light switch can turn on upon “seeing” a person in its view, without the person manually operating the light switch.
backbone network—a “transit” network often made up of long-distance telephone trunk lines and/or other wired and/or wireless links such as microwave and satellite links for use in transmitting large amounts of data simultaneously between host computer systems connected to the Internet. Normal communicated data typically neither originates nor terminates in a backbone network.
Boolean logic—a complete system for logical operations.
can—is capable of, in at least some embodiments.
cause—to produce an effect.
circuit—a physical system comprising: an electrically conductive pathway and/or a communications connection established across a switching device (such as logic gates); and/or an electrically conductive pathway and/or a communications connection established across two or more switching devices comprised by a network and between corresponding end systems connected to, but not comprised by the network.
comprising—including but not limited to.
configure—to make suitable or fit for a specific use or situation. containing—including but not limited to. convert—to transform, adapt, and/or change. create—to bring into being.
data—distinct pieces of information, usually formatted in a special or predetermined way and/or organized to express concepts, and/or represented in a form suitable for processing by an information device.
data structure—an organization of a collection of data that allows the data to be manipulated effectively and/or a logical relationship among data elements that is designed to support specific data manipulation functions. A data structure can comprise meta data to describe the properties of the data structure. Examples of data structures can include: array, dictionary, graph, hash, heap, linked list, matrix, object, queue, ring, stack, tree, and/or vector.
define—to establish the outline, form, or structure of
determine—to obtain, calculate, decide, deduce, and/or ascertain.
device—a machine, manufacture, and/or collection thereof digital—non-analog and/or discrete.
device user—user of the information device.
estimate—to calculate and/or determine approximately and/or tentatively.
first device user—user of the first information device.
generate—to create, produce, give rise to, and/or bring into existence.
haptic—involving the human sense of kinesthetic movement and/or the human sense of touch. Among the many potential haptic experiences are numerous sensations, body-positional differences in sensations, and time-based changes in sensations that are perceived at least partially in non-visual, non-audible, and non-olfactory manners, including the experiences of tactile touch (being touched), active touch, grasping, pressure, friction, traction, slip, stretch, force, torque, impact, puncture, vibration, motion, acceleration, jerk, pulse, orientation, limb position, gravity, texture, gap, recess, viscosity, pain, itch, moisture, temperature, thermal conductivity, and thermal capacity.
having—including but not limited to.
human-machine interface—hardware and/or software adapted to render information to a user and/or receive information from the user; and/or a user interface.
including—including but not limited to.
information device—any device capable of processing data and/or information, such as any general purpose and/or special purpose computer, such as a personal computer, workstation, server, minicomputer, mainframe, supercomputer, computer terminal, laptop, wearable computer, and/or Personal Digital Assistant (PDA), mobile terminal, Bluetooth device, communicator, “smart” phone (such as an iPhone and/or Galaxy-like device), messaging service (e.g., Blackberry) receiver, pager, facsimile, cellular telephone, a traditional telephone, telephonic device, a programmed microprocessor or microcontroller and/or peripheral integrated circuit elements, an ASIC or other integrated circuit, a hardware electronic logic circuit such as a discrete element circuit, and/or a programmable logic device such as a PLD, PLA, FPGA, or PAL, or the like, etc. In general any device on which resides a finite state machine capable of implementing at least a portion of a method, structure, and/or or graphical user interface described herein may be used as an information device. An information device can comprise components such as one or more network interfaces, one or more processors, one or more memories containing instructions, and/or one or more input/output (I/O) devices, one or more user interfaces coupled to an I/O device, etc.
initialize—to prepare something for use and/or some future event.
input/output (I/O) device—any sensory-oriented input and/or output device, such as an audio, visual, haptic, olfactory, and/or taste-oriented device, including, for example, a monitor, display, projector, overhead display, keyboard, keypad, mouse, trackball, joystick, gamepad, wheel, touchpad, touch panel, pointing device, microphone, speaker, video camera, camera, scanner, printer, haptic device, vibrator, tactile simulator, and/or tactile pad, potentially including a port to which an I/O device can be attached or connected.
instructions—directions, which can be implemented as firmware and/or software, the directions adapted to perform a particular operation or function.
logic gate—a physical device adapted to perform a logical operation on one or more logic inputs and to produce a single logic output, which is manifested physically. Because the output is also a logic-level value, an output of one logic gate can connect to the input of one or more other logic gates, and via such combinations, complex operations can be performed. The logic normally performed is Boolean logic and is most commonly found in digital circuits. The most common implementations of logic gates are based on electronics using resistors, transistors, and/or diodes, and such implementations often appear in large arrays in the form of integrated circuits (a.k.a., IC's, microcircuits, microchips, silicon chips, and/or chips). It is possible, however, to create logic gates that operate based on vacuum tubes, electromagnetics (e.g., relays), mechanics (e.g., gears), fluidics, optics, chemical reactions, and/or DNA, including on a molecular scale. Each electronically-implemented logic gate typically has two inputs and one output, each having a logic level or state typically physically represented by a voltage. At any given moment, every terminal is in one of the two binary logic states (“false” (a.k.a., “low” or “0”) or “true” (a.k.a., “high” or “1”), represented by different voltage levels, yet the logic state of a terminal can, and generally does, change often, as the circuit processes data. Thus, each electronic logic gate typically requires power so that it can source and/or sink currents to achieve the correct output voltage. Typically, machine instructions are ultimately encoded into binary values of “0”s and/or “1”s and, are typically written into and/or onto a memory device, such as a “register”, which records the binary value as a change in a physical property of the memory device, such as a change in voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc. An exemplary register might store a value of “01101100”, which encodes a total of 8 “bits” (one byte), where each value of either “0” or “1” is called a “bit” (and 8 bits are collectively called a “byte”). Note that because a binary bit can only have one of two different values (either “0” or “1”), any physical medium capable of switching between two saturated states can be used to represent a bit. Therefore, any physical system capable of representing binary bits is able to represent numerical quantities, and potentially can manipulate those numbers via particular encoded machine instructions. This is one of the basic concepts underlying digital computing. At the register and/or gate level, a computer does not treat these “0”s and “1”s as numbers per se, but typically as voltage levels (in the case of an electronically-implemented computer), for example, a high voltage of approximately +3 volts might represent a “1” or “logical true” and a low voltage of approximately 0 volts might represent a “0” or “logical false” (or vice versa, depending on how the circuitry is designed). These high and low voltages (or other physical properties, depending on the nature of the implementation) are typically fed into a series of logic gates, which in turn, through the correct logic design, produce the physical and logical results specified by the particular encoded machine instructions. For example, if the encoding request a calculation, the logic gates might add the first two bits of the encoding together, produce a result “1” (“0”+“1”=“1”), and then write this result into another register for subsequent retrieval and reading. Or, if the encoding is a request for some kind of service, the logic gates might in turn access or write into some other registers which would in turn trigger other logic gates to initiate the requested service.
logical—a conceptual representation.
machine instructions—directions adapted to cause a machine, such as an information device, to perform one or more particular activities, operations, or functions. The directions, which can sometimes form an entity called a “processor”, “kernel”, “operating system”, “program”, “application”, “utility”, “subroutine”, “script”, “macro”, “file”, “project”, “module”, “library”, “class”, and/or “object”, etc., can be embodied as machine code, source code, object code, compiled code, assembled code, interpretable code, and/or executable code, etc., in hardware, firmware, and/or software.
machine-readable medium—a physical structure from which a machine, such as an information device, computer, microprocessor, and/or controller, etc., can store and/or obtain machine-implementable instructions, data, and/or information.
Examples include a memory device, punch cards, etc.
manually—by one or more people, users, and/or system administrators, including but not limited to, through the use of software sent to an information device, the software adapted for such purpose.
may—is allowed and/or permitted to, in at least some embodiments.
memory device—an apparatus capable of storing, sometimes permanently, machine-implementable instructions, data, and/or information, in analog and/or digital format. Examples include at least one non-volatile memory, volatile memory, register, relay, switch, Random Access Memory, RAM, Read Only Memory, ROM, flash memory, magnetic media, hard disk, floppy disk, magnetic tape, optical media, optical disk, compact disk, CD, digital versatile disk, DVD, and/or raid array, etc. The memory device can be coupled to a processor and/or can store and provide instructions adapted to be executed by processor, such as according to an embodiment disclosed herein.
method—one or more acts that are performed upon subject matter to be transformed to a different state or thing and/or are tied to a particular apparatus, said one or more acts not a fundamental principal and not pre-empting all uses of a fundamental principal.
network—a communicatively coupled plurality of nodes, communication devices, and/or information devices. Via a network, such nodes and/or devices can be linked, such as via various wireline and/or wireless media, such as cables, telephone lines, power lines, optical fibers, radio waves, and/or light beams, etc., to share resources (such as printers and/or memory devices), exchange files, and/or allow electronic communications therebetween. A network can be and/or can utilize any of a wide variety of sub-networks and/or protocols, such as a circuit switched, public-switched, packet switched, connection-less, wireless, virtual, radio, data, telephone, twisted pair, POTS, non-POTS, DSL, cellular, telecommunications, video distribution, cable, terrestrial, microwave, broadcast, satellite, broadband, corporate, global, national, regional, wide area, backbone, packet-switched TCP/IP, IEEE 802.03, Ethernet, Fast Ethernet, Token Ring, local area, wide area, IP, public Internet, intranet, private, ATM, Ultra Wide Band (UWB), Wi-Fi, BlueTooth, Airport, IEEE 802.11, IEEE 802.11a, IEEE 802.11b, IEEE 802.11g, X-10, electrical power, multi-domain, and/or multi-zone sub-network and/or protocol, one or more Internet service providers, one or more network interfaces, and/or one or more information devices, such as a switch, router, and/or gateway not directly connected to a local area network, etc., and/or any equivalents thereof.
network interface—any physical and/or logical device, system, and/or process capable of coupling an information device to a network. Exemplary network interfaces comprise a telephone, cellular phone, cellular modem, telephone data modem, fax modem, wireless transceiver, communications port, ethernet card, cable modem, digital subscriber line interface, bridge, hub, router, or other similar device, software to manage such a device, and/or software to provide a function of such a device.
on-demand cut-and-sew apparel—manufactured items, including but not limited to apparel items, and/or including but not limited to cut-and-sew items, and/or including but not limited to items manufactured on demand.
packet—a generic term for a bundle of data organized in a specific way for transmission, such as within and/or across a network, such as a digital packet-switching network, and comprising the data to be transmitted and certain control information, such as a destination address.
perceptible—capable of being perceived by the human senses. physical—tangible, real, and/or actual.
physically—existing, happening, occurring, acting, and/or operating in a manner that is tangible, real, and/or actual. plurality—the state of being plural and/or more than one.
predetermined—established in advance.
probability—a quantitative representation of a likelihood of an occurrence.
processor—a hardware, firmware, and/or software machine and/or virtual machine physically adaptable to perform, via boolean logic operating on a plurality of logic gates, a specific task defined by a set of machine-implementable instructions. A processor can utilize mechanical, pneumatic, hydraulic, electrical, magnetic, optical, informational, chemical, and/or biological principles, mechanisms, adaptations, signals, inputs, and/or outputs to perform the task(s). In certain embodiments, a processor can act upon information by manipulating, analyzing, modifying, and/or converting it, transmitting the information for use by machine-implementable instructions and/or an information device, and/or routing the information to an output device. A processor can function as a central processing unit, local controller, remote controller, parallel controller, and/or distributed controller, etc. Unless stated otherwise, the processor can be a general-purpose device, such as a microcontroller and/or a microprocessor, such the Pentium family of microprocessor manufactured by the Intel Corporation of Santa Clara, Calif. In certain embodiments, the processor can be dedicated purpose device, such as an Application Specific Integrated Circuit (ASIC) or a Field Programmable Gate Array (FPGA) that has been designed to implement in its hardware and/or firmware at least a part of an embodiment disclosed herein. A processor can reside on and use the capabilities of a controller.
programmatically—using one or more algorithms, procedures, calculations, macros, software programs, machine instructions and/or other such utilities adapted for such purpose, including but not limited to those installed on a server and/or information device.
project—to calculate, estimate, or predict.
provide—to furnish, supply, give, and/or make available.
receive—to get as a signal, take, acquire, and/or obtain.
recommend—to suggest, praise, commend, and/or endorse.
render—to make perceptible to a human, for example as data, commands, text, graphics, audio, video, animation, and/or hyperlinks, etc., such as via any visual, audio, and/or haptic means, such as via a display, monitor, electric paper, ocular implant, cochlear implant, speaker, etc.
repeatedly—again and again; repetitively.
request—to express a desire for and/or ask for.
second device user—user of the second information device.
select—to make a choice or selection from alternatives.
server—an information device and/or a process running thereon, that is adapted to be communicatively coupled to a network and that is adapted to provide at least one service for at least one client, i.e., for at least one other information device communicatively coupled to the network and/or for at least one process running on another information device communicatively coupled to the network. One example is a file server, which has a local drive and services requests from remote clients to read, write, and/or manage files on that drive. Another example is an e-mail server, which provides at least one program that accepts, temporarily stores, relays, and/or delivers e-mail messages. Still another example is a database server, which processes database queries. Yet another example is a device server, which provides networked and/or programmable: access to, and/or monitoring, management, and/or control of, shared physical resources and/or devices, such as information devices, printers, modems, scanners, projectors, displays, lights, cameras, security equipment, proximity readers, card readers, kiosks, POS/retail equipment, phone systems, residential equipment, HVAC equipment, medical equipment, laboratory equipment, industrial equipment, machine tools, pumps, fans, motor drives, scales, programmable logic controllers, sensors, data collectors, actuators, alarms, annunciators, and/or input/output devices, etc.
set—a related plurality.
signal—information, such as machine instructions for activities and/or one or more letters, words, characters, symbols, signal flags, visual displays, and/or special sounds, etc. having prearranged meaning, encoded as automatically detectable variations in a physical variable, such as a pneumatic, hydraulic, acoustic, fluidic, mechanical, electrical, magnetic, optical, chemical, and/or biological variable, such as power, energy, pressure, flowrate, viscosity, density, torque, impact, force, frequency, phase, voltage, current, resistance, magnetomotive force, magnetic field intensity, magnetic field flux, magnetic flux density, reluctance, permeability, index of refraction, optical wavelength, polarization, reflectance, transmittance, phase shift, concentration, and/or temperature, etc. Depending on the context, a signal and/or the information encoded therein can be synchronous, asynchronous, hard real-time, soft real-time, non-real time, continuously generated, continuously varying, analog, discretely generated, discretely varying, quantized, digital, broadcast, multicast, unicast, transmitted, conveyed, received, continuously measured, discretely measured, processed, encoded, encrypted, multiplexed, modulated, spread, de-spread, demodulated, detected, de-multiplexed, decrypted, and/or decoded, etc.
special purpose computer—a computer and/or information device comprising a processor device having a plurality of logic gates, whereby at least a portion of those logic gates, via execution of specific machine instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine instructions to the logic gate's specific configuration and property(ies). In the context of an electronic computer, each such change in the logic gates creates a specific electrical circuit, thereby directly tying the specific machine instructions to that specific electrical circuit.
special purpose processor—a processor device, having a plurality of logic gates, whereby at least a portion of those logic gates, via execution of specific machine instructions by the processor, experience a change in at least one physical and measurable property, such as a voltage, current, charge, phase, pressure, weight, height, tension, level, gap, position, velocity, momentum, force, temperature, polarity, magnetic field, magnetic force, magnetic orientation, reflectivity, molecular linkage, molecular weight, etc., thereby directly tying the specific machine instructions to the logic gate's specific configuration and property(ies). In the context of an electronic computer, each such change in the logic gates creates a specific electrical circuit, thereby directly tying the specific machine instructions to that specific electrical circuit.
store—to place, hold, and/or retain data, typically in a memory.
substantially—to a great extent or degree.
system—a collection of mechanisms, devices, machines, articles of manufacture, processes, data, and/or instructions, the collection designed to perform one or more specific functions.
system user—an administrative and/or system-level user with appropriate permissions in a system.
transform—to change in measurable: form, appearance, nature, and/or character.
transmit—to send as a signal, provide, furnish, and/or supply.
user interface—any device for rendering information to a user and/or requesting information from the user. A user interface includes at least one of textual, graphical, audio, video, animation, and/or haptic elements. A textual element can be provided, for example, by a printer, monitor, display, projector, etc. A graphical element can be provided, for example, via a monitor, display, projector, and/or visual indication device, such as a light, flag, beacon, etc. An audio element can be provided, for example, via a speaker, microphone, and/or other sound generating and/or receiving device. A video element or animation element can be provided, for example, via a monitor, display, projector, and/or other visual device. A haptic element can be provided, for example, via a very low frequency speaker, vibrator, tactile stimulator, tactile pad, simulator, keyboard, keypad, mouse, trackball, joystick, gamepad, wheel, touchpad, touch panel, pointing device, and/or other haptic device, etc. A user interface can include one or more textual elements such as, for example, one or more letters, number, symbols, etc. A user interface can include one or more graphical elements such as, for example, an image, photograph, drawing, icon, window, title bar, panel, sheet, tab, drawer, matrix, table, form, calendar, outline view, frame, dialog box, static text, text box, list, pick list, pop-up list, pull-down list, menu, tool bar, dock, check box, radio button, hyperlink, browser, button, control, palette, preview panel, color wheel, dial, slider, scroll bar, cursor, status bar, stepper, and/or progress indicator, etc. A textual and/or graphical element can be used for selecting, programming, adjusting, changing, specifying, etc. an appearance, background color, background style, border style, border thickness, foreground color, font, font style, font size, alignment, line spacing, indent, maximum data length, validation, query, cursor type, pointer type, autosizing, position, and/or dimension, etc. A user interface can include one or more audio elements such as, for example, a volume control, pitch control, speed control, voice selector, and/or one or more elements for controlling audio play, speed, pause, fast forward, reverse, etc. A user interface can include one or more video elements such as, for example, elements controlling video play, speed, pause, fast forward, reverse, zoom-in, zoom-out, rotate, and/or tilt, etc. A user interface can include one or more animation elements such as, for example, elements controlling animation play, pause, fast forward, reverse, zoom-in, zoom-out, rotate, tilt, color, intensity, speed, frequency, appearance, etc. A user interface can include one or more haptic elements such as, for example, elements utilizing tactile stimulus, force, pressure, vibration, motion, displacement, temperature, etc.
via—by way of and/or utilizing.
weight—a value indicative of importance.

### Notes

Still other substantially and specifically practical and useful embodiments will become readily apparent to those skilled in this art from reading the above-recited and/or herein-included detailed description and/or drawings of certain exemplary embodiments. It should be understood that numerous variations, modifications, and additional embodiments are possible, and accordingly, all such variations, modifications, and embodiments are to be regarded as being within the scope of this application.

Thus, regardless of the content of any portion (e.g., title, field, background, summary, description, abstract, drawing figure, etc.) of this application, unless clearly specified to the contrary, such as via explicit definition, assertion, or argument, with respect to any claim, whether of this application and/or any claim of any application claiming priority hereto, and whether originally presented or otherwise: there is no requirement for the inclusion of any particular described or illustrated characteristic, function, activity, or element, any particular sequence of activities, or any particular interrelationship of elements; no characteristic, function, activity, or element is “essential”; any elements can be integrated, segregated, and/or duplicated; any activity can be repeated, any activity can be performed by multiple entities, and/or any activity can be performed in multiple jurisdictions; and any activity or element can be specifically excluded, the sequence of activities can vary, and/or the interrelationship of elements can vary.

Moreover, when any number or range is described herein, unless clearly stated otherwise, that number or range is approximate. When any range is described herein, unless clearly stated otherwise, that range includes all values therein and all subranges therein. For example, if a range of 1 to 10 is described, that range includes all values therebetween, such as for example, 1.1, 2.5, 3.335, 5, 6.179, 8.9999, etc., and includes all subranges therebetween, such as for example, 1 to 3.65, 2.8 to 8.14, 1.93 to 9, etc.

When any claim element is followed by a drawing element number, that drawing element number is exemplary and non-limiting on claim scope. No claim of this application is intended to invoke paragraph six of 35 USC 112 unless the precise phrase “means for” is followed by a gerund.

Any information in any material (e.g., a United States patent, United States patent application, book, article, etc.) that has been incorporated by reference herein, is only incorporated by reference to the extent that no conflict exists between such information and the other statements and drawings set forth herein. In the event of such conflict, including a conflict that would render invalid any claim herein or seeking priority hereto, then any such conflicting information in such material is specifically not incorporated by reference herein.

Accordingly, every portion (e.g., title, field, background, summary, description, abstract, drawing figure, etc.) of this application, other than the claims themselves, is to be regarded as illustrative in nature, and not as restrictive, and the scope of subject matter protected by any patent that issues based on this application is defined only by the claims of that patent.

What is claimed is:

1. A method comprising:
from a server, sending apparel customization software to a first information device, the software adapted to enable the user of the first information device to input one or more customizations for a cut-and-sew apparel item; via said server, creating a communication session linking said first information device to said server; at said server, from said apparel customization software running on said first information device, receiving data associated with said customizations; from said server, sending apparel customization administration software to a second information device, the software adapted to enable the user of the second information device to manage the production process for customized cut-and-sew apparel items; via said server, creating a communication session linking said second information device to said server; and at said second information device, from said server, receiving data associated with said customizations.

2. The method of claim 1, further comprising:
said apparel customization software running on said first information device further adapted to generate one or more preview images incorporating data associated with said customizations upon input from the user of the first information device.

3. The method of claim 1, further comprising:
apparel customization server software running on said server, the software adapted to initiate of one or more steps in the production process for customized cut-and-sew apparel items upon receiving said data associated with said customizations from said first information device.

4. The method of claim 1, further comprising:
apparel customization server software running on said server, the software adapted to generate one or more preview images incorporating data associated with said customizations upon receiving said data from said first information device.

5. The method of claim 1, further comprising:
said apparel customization administration software running on said second information device further adapted to enable automatic initiation of one or more steps in the production process for customized cut-and-sew apparel items upon receiving data associated with said customizations from said server.

6. The method of claim 1, further comprising:
said apparel customization administration software running on said second information device further adapted to generate one or more preview images incorporating data associated with said customizations upon receiving said data from said server.

7. The method of claim 1, further comprising:
said apparel customization administration software running on said second information device further adapted to generate one or more production files, including but not limited to image files, incorporating data associated with said customizations upon receiving said data from said server.

8. The method of claim 1, further comprising:
apparel customization server software running on said server, the software adapted to generate one or more design variant images from one or more original design images, by adjusting color, scale, rotation, position, brightness, contrast, saturation, grayscale, inversion, composition and/or opacity.

9. The method of claim 1, further comprising:
said apparel customization administration software running on said second information device further adapted to generate one or more design variant images from one or more original design images, by adjusting color, scale, rotation, position, brightness, contrast, saturation, grayscale, inversion, composition and/or opacity.

10. The method of claim 1, further comprising:
apparel customization server software running on said server, the software adapted to generate one or more production files, including but not limited to image files, incorporating data associated with said customizations upon receiving said data from said first information device.

11. The method of claim 10, further comprising:
at said second information device, from said server, receiving data associated with said production files, said apparel customization administration software running on said second information device further adapted to enable the user of the second information device to print one or more of said production files on a fabric printer.

12. The method of claim 10, further comprising:
at said second information device, from said server, receiving data associated with said production files, said apparel customization administration software running on said second information device further adapted to enable the user of the second information device, using said data, to cut fabric pattern pieces on a fabric cutting machine.

13. The method of claim 10, further comprising:
at said second information device, from said server, receiving data associated with said production files, said apparel customization administration software running on said second information device further adapted to enable the user of the second information device, using said data, to sew fabric pattern pieces on a fabric sewing machine.
